(19) United States
(12) Patent Application Publication
(10) Pub. No.: US 2008/0073288 A1
(43) Pub. Date: Mar. 27, 2008

(54) Multifunctional filtration and water purification systems

(76) Inventors: Qinbai Fan, Chicago, IL (US); Jeremy R. Chervinko, Streamwood, IL (US); Renxuan Liu, Chicago, IL (US)

Correspondence Address: MORRISON & FOERSTER LLP, 755 PAGE MILL RD, PALO ALTO, CA, 94304-1018, US

(21) Appl. No.: 11/888,834

(22) Filed: Aug. 1, 2007

Related U.S. Application Data
(63) Continuation-in-part of application No. 11/724,534, filed on Mar. 14, 2007.
Application No. 11/724,534 is a continuation-in-part of application No. 11/515,544, filed on Sep. 5, 2006.
Application No. 11/515,544 is a continuation-in-part of application No. 11/497,092, filed on Aug. 1, 2006.
(60) Provisional application No. 60/794,287, filed on Apr. 21, 2006.

(51) Int. Cl. C02F 1/46

(52) U.S. Cl. 210/748; 210/243

(57) ABSTRACT

A water purification system having a porous anode electrode (21) and a porous cathode electrode (20), each of which is made of graphite, at least one metal oxide, and an ion-exchange, cross-linked, polarizable polymer, and optionally comprises microchannels. Disposed between the electrodes is a non-electron conductive, fluid permeable separator element (22), whereby wastewater is able to flow from one electrode to the other electrode. The electrodes and separator may be disposed within a housing (23) having a wastewater inlet opening (24), and exhaust waste outlet opening (26) and a purified water outlet opening (25). In this way, components of the system are easily replaced should the need arise.

### CROSS-REFERENCE TO RELATED APPLICATIONS

This application is a continuation-in-part of U.S. patent application Ser. No. 11/724,534, filed on Mar. 14, 2007, which is a continuation-in-part of U.S. patent application Ser. No. 11/515,544, filed on Sep. 5, 2006, which is a continuation-in-part of U.S. patent application Ser. No. 11/497,092, filed on Aug. 1, 2006, which claims priority benefit of U.S. Provisional Application No. 60/794,287, filed Apr. 21, 2006. This application is related to the PCT International Application entitled “Multifunctional Filtration and Water Purification Systems” by inventors Qinbai Fan, Jeremy R. Chervinko, and Renxuan Liu filed concurrently with the present application. The entire contents of those applications are herby incorporated by reference herein.

### BACKGROUND OF THE INVENTION

1. Field of the Invention

This invention relates to an apparatus for water purification. More particularly, this invention relates to a multi-functional apparatus for water purification having the functionalities of ion-exchange, carbon adsorption, electrochemical ionic adsorption and desorption, and microfiltration. The apparatus is capable of removing ionized and non-ionized organic compounds, inorganic ions, particulates and bacteria from wastewater streams in a single unit to produce potable water. Porous carbon-based electrodes with polymer binders function as impurity filters to remove particulate matter, such as ash, sand and high molecular weight compounds, as electrodes to concentrate and remove ionic species, and as adsorbents to remove organic materials and bacteria from the wastewater stream.

2. Description of Related Art

Known water purification methods include distillation, ion-exchange, carbon adsorption, filtration, ultrafiltration, reverse osmosis, electrodeionization, capacitive deionization, ultraviolet radiation, and combinations thereof. However, each of these methods has shortcomings. Distillation cannot remove some volatile organics and it consumes large amounts of energy. In ion-exchange processes, water is percolated through bead-like spherical resin materials. However, the resin materials need to be regenerated and changed frequently. In addition, this method does not effectively remove particles, pyrogens, or bacteria. Carbon adsorption processes can remove dissolved organics and chlorine with long life and high capacity; however, fine carbon particles are generated during the process due to corrosion. Micropore membrane filtration, a high cost process, removes all particles and microorganisms greater than the pore size of the membrane; however, it cannot remove dissolved inorganics, pyrogens or colloids. The ultrafilter is a tough, thin, selectively permeable membrane that retains most macromolecules above a certain size, including colloids, microorganisms, and pyrogens; however, it will not remove dissolved organics. Reverse osmosis is the most economical method for removing 90 to 99% of all contaminants. Reverse osmosis membranes are capable of rejecting all particles, bacteria, and organics; however, the flow rate and productivity are low. Electrodeionization, which is the subject matter of U.S. Pat. No. 6,824,662 B2 to Liang et al., is a combination of electrodialysis and ion-exchange, resulting in a process which effectively deionizes water while the ion-exchange resins are continuously regenerated by the electric current; however, this method requires pre-purification to remove powders and ash materials. Ultraviolet radiation cannot remove ionized inorganics.

FIG. 1 is a diagram showing a capacitive deionization process with carbon aerogel electrodes. In this process, salt water is introduced into the cell, the negative electrode (anode) 11 adsorbs positive ions 13 and the positive electrode (cathode) 12 adsorbs negative ions 14. When the cell is charged, pure water is obtained, and when the cell is discharged, concentrated salt water is removed. To achieve this result, pulsed electrical power at voltages from 1.2V to 0V is used for different time periods depending on the concentration of the salt water and the activity of the activated carbon. The more accessible surface area the electrode, the more ions that can be stored. The main problem with this method is that the electrosorption capacity (salt removal) decreases with cycle life. Most of the capacity loss can be recovered by periodic reversing of the electrode polarization. However, the interface between the active carbon and the aerogel diminishes, reducing the actual electrode active area. Ultimately, the carbon particles will no longer contact each other and will leach out. In addition, capacitive deionization requires aggressive pre-filtration and cannot remove non-ionic species.

An electrically regenerable electrochemical cell for capacitive deionization and electrochemical purification and regeneration of electrodes is taught by U.S. Pat. No. 6,309,532 B1 to Tran et al. The cell includes two end plates, one at each end of the cell, and a plurality of generally identical double-sided intermediate electrodes that are equidistantly separated from each other between the two end plates. The electrodes comprise a Ti substrate coated with carbon gel (carbon aerogel). As the electrolyte enters the cell, it flows through a continuous serpentine channel formed by the electrodes, substantially parallel to the electrodes. By polarizing the cell, ions are removed from the electrolyte and are held in electric double layers formed at the carbon aerogel surfaces of the electrodes. The cell is regenerated electrically to desorb the previously removed ions. However, by virtue of the serpentine flow arrangement between the electrode plates, the useful area for the electrodes is limited to the electrode surface.

There is a need for an improved water filtration device which is capable of removing particulate material, inorganic ions, ionic and non-ionic organic substances, and/or bacteria from water containing such substances.

### SUMMARY OF THE INVENTION

It is one object of this invention to provide a method and apparatus for wastewater purification which addresses various shortcomings of the known methods and systems for wastewater purification.

In one instance, the invention provides an apparatus for wastewater purification which removes ionized and non-ionized organic materials, inorganic ions, particulates and bacteria in a single unit process.

Disclosed is an apparatus for water purification comprising a multi-functional, porous, carbon-based composite electrode comprising a resin (e.g. ion-exchange resin) as a binder, carbon black and/or graphite as active adsorbents, and metal oxides as adsorbent promoters. The porous carbon-based plates may be molded by mixing metal oxides, carbon and/or graphite powders, polymer resin and a bubbling agent, such as ammonium bicarbonate. The resins are cross-linked for stability and the porosity of the resulting electrode plate is more than about 50%, for example, about 50% to about 80%, by volume.

In another aspect, electrodes for use in water purification are provided, which electrodes function as electrical field suppliers, ion-exchange resin holders, and colloid powders filters. In operation, the positive electrode absorbs negative ions while the negative electrode adsorbs positive ions.

In another aspect, an apparatus for water purification is provided comprising a porous anode electrode, a porous cathode electrode, and an electrically non-conductive, fluid permeable separator element disposed between the anode electrode and the cathode electrode. Each of the electrodes comprises graphite, at least one metal oxide, and an ion-exchange, cross-linked, polarizable polymer. The electrodes and separator element are preferably disposed in an electrically nonconductive housing having a wastewater inlet opening and a purified water outlet opening and may be used in a single cell configuration or in a series configuration with additional cell units. The apparatus of this invention acts as a filter, organic and bacteria adsorbent and also functions as a desalination system. The apparatus may also be used to concentrate soluble salts from a dilute aqueous solution. One application for the water purification system of this invention is marine water desalination.

In another aspect, a water purification system is provided comprising a porous first electrode having a first average pore diameter and a porous second electrode having a second average pore diameter, each of the electrodes comprising microchannels having an average diameter larger than the first average pore diameter or the second average pore diameter.

In another aspect, a method of removing impurities in water is provided, comprising the steps of: applying a voltage to the electrodes of the water purification system described herein; contacting said electrodes with water, whereby impurities in said water are removed by one of said electrodes; and collecting said water from said electrodes.

### BRIEF DESCRIPTION OF THE DRAWINGS

FIG. 1 depicts a conventional capacitive deionization method.

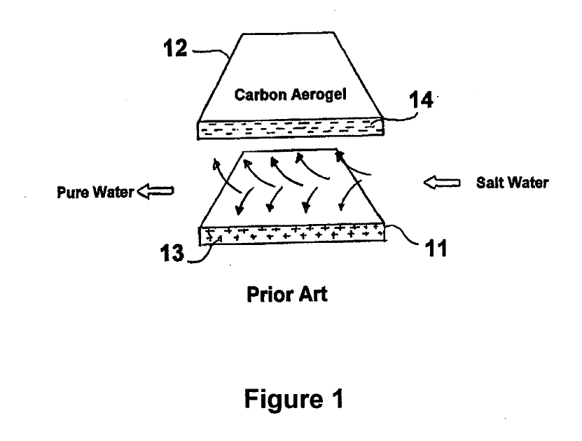

FIG. 2 is a schematic diagram showing a single cell compartment for wastewater treatment in accordance with one embodiment of this invention.

FIG. 3 is a schematic diagram showing a multi-cell compartment for wastewater treatment in accordance with one embodiment of this invention.

FIG. 4 is a schematic diagram showing a two-stage water purification system in accordance with one embodiment of this invention.

FIG. 5 schematically depicts microchannels in the porous electrode, as described in Example 8.

FIG. 6A is a schematic diagram of a water purification system in accordance with one embodiment of this invention. FIG. 6B schematically depicts voltage changes with electrode couples in series, as shown in the system depicted in FIG. 6A.

FIG. 7 schematically depicts a water purification system in which solenoid valves are used for discharge of particulate impurities from the water stream.

FIG. 8 is a schematic diagram of a water purification system in accordance with one embodiment of this invention.

FIG. 9 is a schematic diagram of an automated water purification apparatus containing the water purification system shown in FIG. 8.

FIG. 10 exemplifies an electrode stack in accordance with one embodiment of this invention.

FIG. 11A depicts a current collector in accordance with one embodiment of this invention. FIG. 11B schematically depicts a current collector of FIG. 11A located on each end of an electrode stack.

FIG. 12 schematically depicts assembly of an electrode in the housing of a water purification device as described herein.

FIG. 13 shows water permeability as a function of water pressure in a pressure-driven water filtration device.

FIG. 14 shows water conductivity as a function of time when ferric nitrate is filtered in a pressure-driven water filtration device.

FIG. 15 shows percent salt removal as a function of operating time as described in Example 9.

FIG. 16 shows percent salt removal as a function of operating time as described in Example 9.

### DETAILED DESCRIPTION

The invention provides methods and systems for water purification. Methods and systems described herein are capable of purifying most water streams requiring purification, including but not limited to industrial wastewater, gas and oil field wastewater, and coal mine wastewater, and are well-suited for desalination of salt water. Methods and systems described herein may also be used for purification of drinking water (e.g., removal of ions such as sodium, magnesium, calcium, zinc, and/or lead cations, and/or chloride, sulfate, and/or bromide anions from tap water) and/or purification of industrial waste streams. The system may incorporate electrochemical deionization, microfiltration, carbon adsorption, and ion exchange features to remove organic materials, inorganic materials, bacteria and solid particles. The system may include automated purging of filtered material and particulate buildup for improved efficiency and long term use. The system is often compact, energy efficient, and cost efficient to produce and operate.

System and Method for Water Purification

The invention in one instance provides a water purification system comprising at least two porous carbon-based electrodes, i.e., a porous anode electrode and a porous cathode electrode, with a non-conductive, fluid permeable separator between the two electrodes to prevent excess current flow between the electrodes. The porous electrodes may comprise a carbon-based material (e.g., graphite) for conductivity, at least one oxide (e.g., metal or semi-metal oxide), which may increase water adsorption by the electrode, and at least one resin (e.g., ion-exchange, cross-linked, polarizable polymer) which binds the components of the electrode together and may provide ion-exchange sites for binding ionic compounds in the water stream. In some embodiments, the electrodes also comprise one, two, or more elements from Group-14 (e.g., carbon black), carbon fibers, and/or silica. The porous carbon-based electrodes filter particulate matter that is too large to traverse the pores, electrochemically concentrate and sequester ionic species such as inorganic, e.g., metal, ions and ionized organic compounds, and adsorb non-ionized organic materials and bacteria from a water stream. The ion-exchange polymer component of the electrode may also bind ionized compounds in the water stream. The porous electrodes may optionally comprise one or more skin-like layers of polymer binders, which may aid in filtering fine particles.

In some embodiments, the electrodes contain microchannels through the electrode, covered by a thin layer membrane of the cross-linked polymer at the ends of the microchannels that open to the surface of the electrode or in the interior of the channels. In one embodiment, the electrode comprises front and back surfaces, the microchannels comprise openings at the front and back electrode surfaces, and the electrode comprises a thin layer polymeric membrane covering the microchannel openings on the front and back surfaces of the electrode. The thin layer polymeric membranes may act as microfilters, preventing particulate matter that is larger than the microchannels from flowing into the electrode.

A water purification system of the invention may include a non-conductive housing with at least one inlet to introduce a water stream to be purified into the housing and an outlet through which purified water exits the housing. The water stream flows from the inlet to the outlet through the porous electrodes and separator. The housing may also include at least one waste outlet, through which particulate materials that are too large to traverse the pores of the electrodes may exit.

In some embodiments, the water purification system comprises a plurality of unit cells, each of which contains a pair of porous anode and cathode electrodes as described herein with a nonconductive, water permeable separator between the two electrodes. The unit cells may be arranged in series such that a water stream to be purified traverses the cells sequentially, with water of increasing purity being produced as the water stream proceeds through the series of cells. The inlet for such a water purification system may be located upstream from the first electrode through which the water stream travels in the first unit cell, and the outlet for purified water may be located downstream from the last electrode through which the water stream travels in the last unit cell. The water stream travels from the inlet to the outlet through at least one unit cell (i.e., at least one pair of porous electrodes and the separator between the electrodes) of the water purification system. In one embodiment, the water stream flows through all of the unit cells of the water purification system. In various embodiments, the water purification system includes 2, 3, 4, 5, 6, 7, 8, 9, 10, or more unit cells. In some embodiments, the water purification system includes 2 to 4 unit cells.

In some embodiments, a water purification system as described herein is operated without applied pressure at the water inlet. In other embodiments, the water purification system is operated with applied pressure at the water inlet. In some embodiments, the water purification system is operated at about 1 to about 40 pounds per square inch, or at about 1 to about 30 pounds per square inch, or at about 1 to about 20 pounds per square inch, or at about 5 to about 30 pounds per square inch, or at about 5 to about 15 pounds per square inch, or at about 5 to about 10 pounds per square inch, or at about 10 to about 15 pounds per square inch. In another embodiments, the water purification system is operated at about 5 pounds per square inch, or at about 7.5 pounds per square inch or at about 10 pounds per square inch, or at about 12.5 pounds per square inch, or at about 20 pounds per square inch or at about 30 pounds per square inch, or at about 40 pounds per square inch.

In some embodiments, the invention provides a method for water purification, including introducing a water stream to be purified into a water purification system as described herein. The water purification system may include a housing having an inlet, an outlet and a flowing water stream. The water stream flows from the inlet to the outlet through at least one unit cell that may include a porous anode electrode, a nonconductive fluid permeable separator, and a cathode electrode. Each porous electrode may contain one, two, or more elements from Group-14 (e.g., exfoliated graphite), at least one oxide (e.g., metal or semi-metal oxide), and at least one polymer (e.g., cross-linked polymer with ion exchange groups). The water stream flows through the electrodes and the separator from the anode to the cathode, or from the cathode to the anode. Particulate matter that is too large to traverse the pores of the electrode may exit the housing through a waste outlet. Ionic, organic, and/or bacterial components of the water stream are retained on the electrodes as the water stream flows through the water purification system, and water exiting the system through the outlet contains reduced amounts of these components than the water stream entering through the inlet. In some embodiments, water is purified through a plurality of unit cells arranged in series such that water flows sequentially through the unit cells and the water stream exiting each unit cell contains a reduced amount of ionic, organic, and/or bacterial contamination than the water stream exiting the previous unit cell in the series.

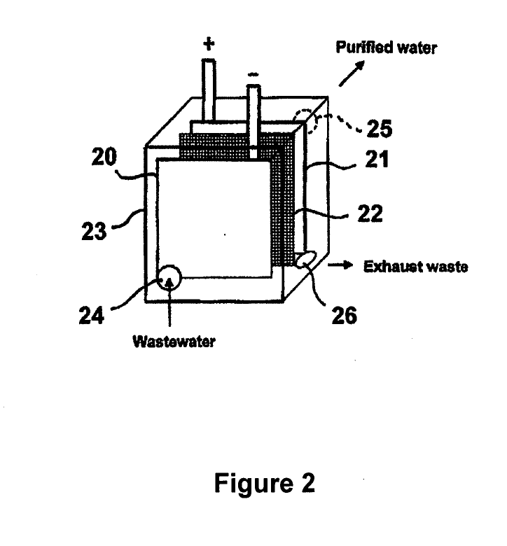

An example of a water purification system in a single cell arrangement in accordance with one embodiment of this invention is shown schematically in FIG. 2. The system comprises a porous cathode electrode 20, a porous anode electrode 21 and an electrically nonconductive, fluid permeable separator element 22 disposed between the anode electrode and the cathode electrode to prevent shorting. Fluid permeable separator element 22 in accordance with one embodiment of this invention is a perforated separator, (e.g., perforated polyethylene or a mesh of polyethylene) having an open area of at least about 60% enabling flow through of the water stream to be purified. In accordance with one embodiment of this invention, the electrodes and the separator element are disposed within an electrically non-conductive, e.g., plastic, housing 23 which is provided with an inlet opening 24 for introducing the water stream to be purified into the cell for processing, an exhaust waste outlet opening 26 through which particulates separated out of the water stream may be removed, and a purified water outlet opening 25 through which purified water may be removed. Thus, in the embodiment shown in FIG. 2, a water stream to be purified is introduced into the housing through inlet opening 24 disposed near the bottom of housing 23 enabling particles and other solid matter in the water stream filtered out by anode electrode 20 to fall to the bottom of the housing for removal through exhaust waste outlet opening 26. One of the benefits of this arrangement is the easy removal of the electrodes for replacement should the need arise. Although the embodiment of the water purification system depicted in FIG. 2 shows water flowing from anode to cathode, in other embodiments, water flow may be from cathode to anode.

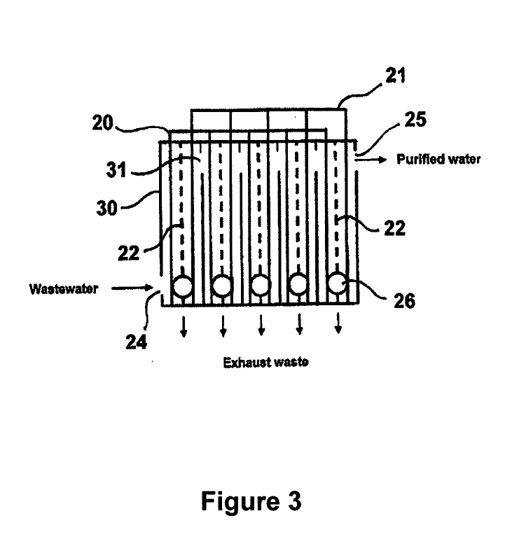

FIG. 3 is a schematic diagram of an example of a water purification system in accordance with one embodiment of this invention comprising a plurality of cell units (i.e., at least two cell units each comprising a pair of porous electrodes with a separator 22 between the electrodes) disposed within a non-conductive housing 30 and arranged for sequential flow of a water stream to be purified through the cells. The water stream is introduced through inlet opening 24 disposed near the bottom of housing 30 into the first cell unit, rises within the cell unit and is forced through the first electrode pair. Particulates within the wastewater fall to the bottom of the housing for removal through exhaust waste outlet opening 26. Upon rising to the top of the first cell unit, the water stream, which is now substantially devoid of particulates passes through intercell fluid opening 31 into the next cell unit for further treatment. The water stream, which becomes successively more purified as it passes through each cell unit, is ultimately passed through purified water outlet opening 25 as substantially pure water.

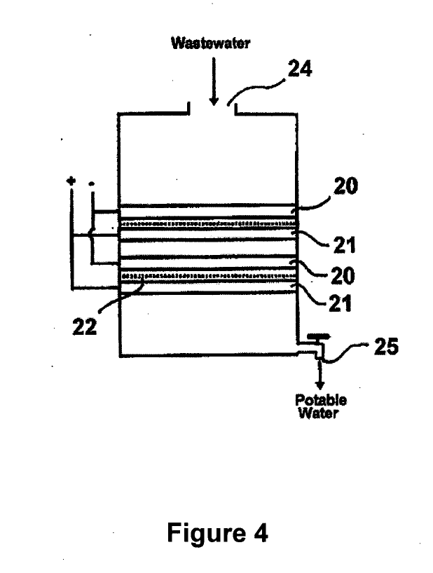

FIG. 4 shows a schematic diagram of a water purification system in accordance with yet another embodiment of this invention having two stages for producing potable water. In this embodiment, a water stream to be purified is introduced through inlet opening 24 at the top of a housing and filters through the two stages of cell units, becoming potable water in the process.

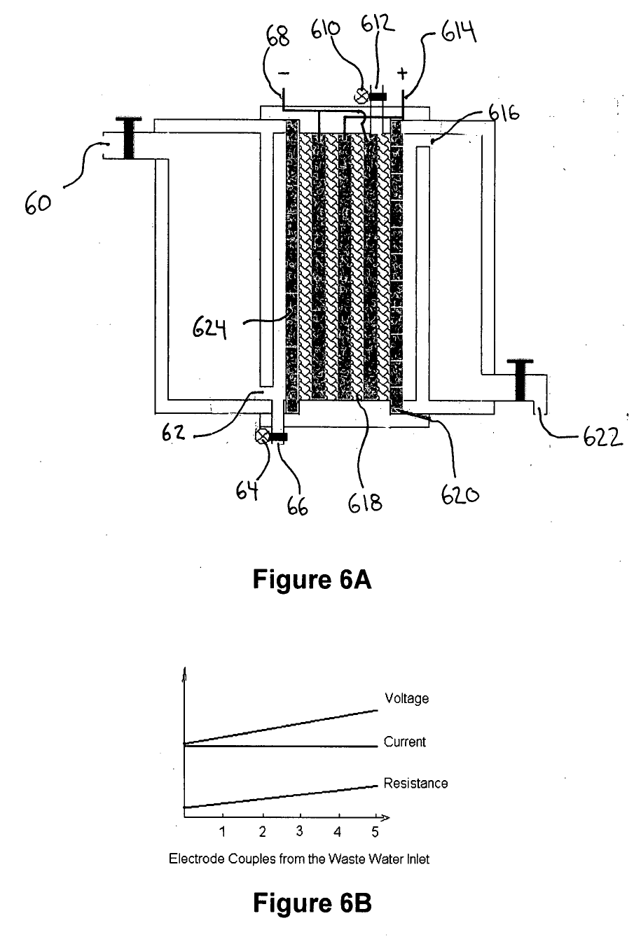

FIG. 6A shows a schematic diagram of a water purification system in accordance with another embodiment of this invention. Water to be purified enters the water purification system through an inlet opening 60 at the top of the device and flows through a slot 62 at the bottom of the device to contact a current collector 624. Several electrodes are arranged in series, with non-conductive water permeable spacers 618 separating the electrodes from each other. End electrodes are connected to positive (614) and negative (68) power supplies. Water flows through the bottom slot 62, into an open area upstream from and parallel to the series of electrodes, flows into a current collector 624, through the series of electrodes, into a second current collector 620, into an open area downstream from and parallel to the series of electrodes, through a slot 616 at the top of the device, and finally exits the device through an outlet opening 622 at the bottom of the water purification system. As depicted in FIG. 6B, the current for such a device remains constant throughout the series of electrodes, but the voltage and water resistance increase from inlet to outlet.

Particulate matter may be trapped near the inlet slot 62 and removed by discharge through a waste outlet 66 close to the inlet slot. The purge may be top-down by air or water through the porous electrodes through a purge opening 612 with the electric current turned off, and optionally may be controlled through a actuated valve 610 (e.g., solenoid valve), as depicted in FIG. 6A.

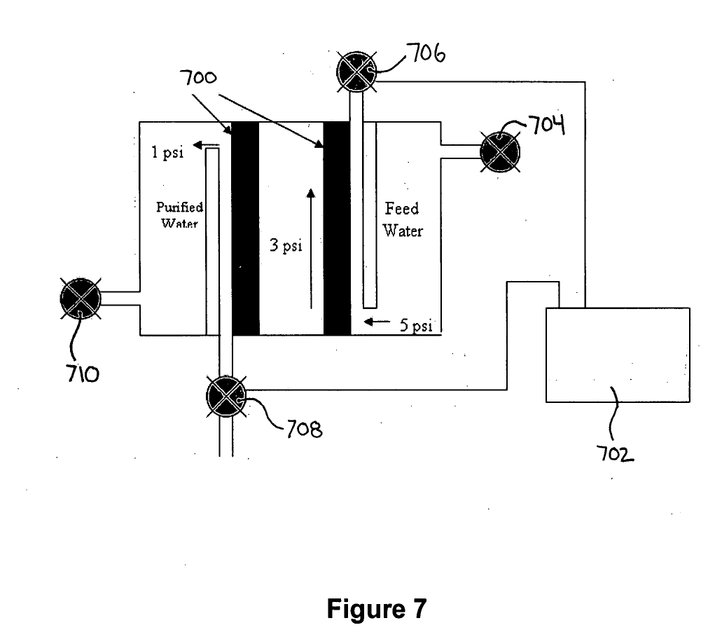

As depicted in the example shown in FIG. 7, if the water flow in the water purification system is at a pressure of 5 psi at the valve/inlet port 704, the water pressure may drop through the electrodes 700. If the water inlet and outlet valve 710 are closed, and the discharge valve 706 (e.g., solenoid valves) are opened, impurities may be released due to the pressure inside the device. Another possible way to release impurities is by pumping air or water from the top to the bottom of the device through valve 708, (or alternatively, from the bottom to the top of the device).

The system may be regenerated by backflushing from 708 to the inlet 704 under a pressure of about 1 to about 40 psi. The backflush may employ pressurized air, clean water, filtered salt water with a lower concentration of salt than the concentrated waste, or the internal pressure of the device. In a device that operates under pressure, shown schematically in FIG. 7, frequent release of waste through a waste outlet is desirable for removal of concentrated impurities. Water may be used to dilute and remove the concentrated waste.

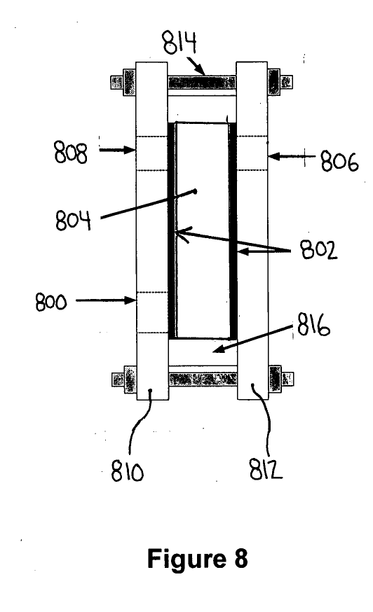

FIG. 8 depicts a water purification system in accordance with another embodiment of the current invention. Water to be purified enters an electrode stack through a water inlet port 800 located at the bottom of endplate 810 and flows through an optionally present current collector plate 802. The water is then purified as it travels through electrodes 804 within the electrode system as described herein while a voltage is applied across oppositely charged electrodes. Purified water exits the system through another optionally present graphite current collector plate 802 and is directed to a water outlet port 806 on another endplate 812 for collection or recirculation. The water outlet port may be used as needed during purging wherein fluid (e.g. water) is pumped into the water outlet port 806 and out the inlet port 800 to flush out accumulated salt in the electrode stack. The system may contain an additional inlet port 808, located on the same endplate 810 as the water inlet port 800, to purge accumulated particulate. The optionally present endplates 810 and 812 (made of, for example, polycarbonate or other injection-moldable plastics) may be used to provide clamping force to the electrode stack assembly (to prevent, for example, water leaks, or damage during handling) and may be clamped together using one or more tie rods 814. In some embodiments, the electrodes of the purification system comprises one or more conductive rods (not shown in FIG. 8) oriented perpendicular to and passing through the electrode stack to allow electrical conductivity at the appropriate electrode plates. The rods may be made of, for example, graphite, and may optionally be positioned outside of the electrode stack rather than within the electrode stack.

Automated Systems

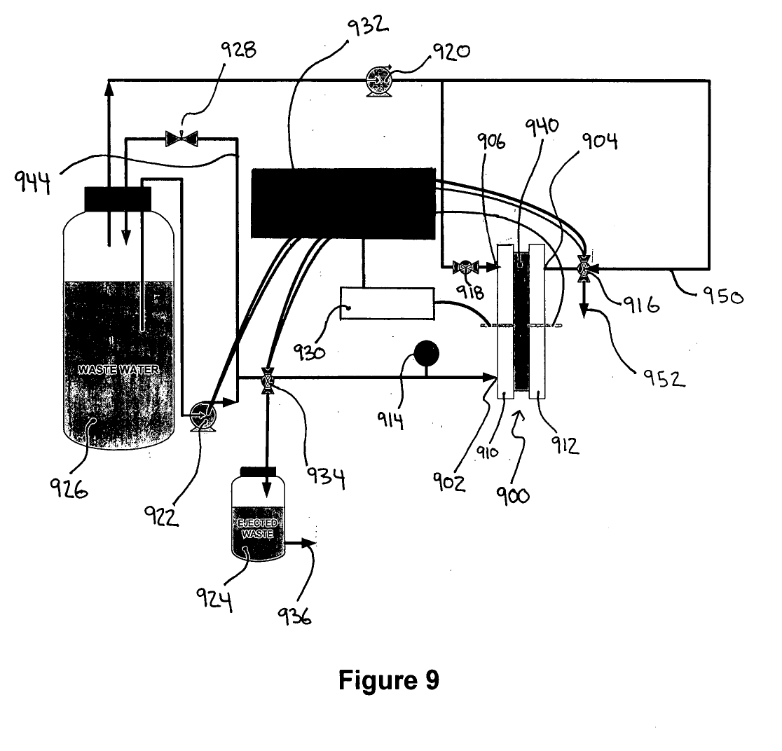

FIG. 9 depicts another embodiment of the present invention, wherein the water purification system 900 described in FIG. 8 is incorporated into an automated continuous water treatment apparatus. Water purification begins with a purification cycle, wherein water from a collection container 926 is directed with a pump 922 through the electrode stack assembly 900 as a voltage is applied by DC power from 930 across the ends of the electrodes 940. Optionally present actuator valves 918 and 934 (e.g., solenoid valves) may be closed during purification to allow purified water exiting the exit port 904 of the electrode stack to be directed through actuator valve 916 and into the collection container for recirculation through line 950, or directly collected from 916 through line 952.

A salt purge cycle may be used to remove salt accumulated within the electrode stack during purification. In one example of a salt purge cycle, positive pressure at the inlet port provided by pump 922 is released (e.g., by turning off the pump) and the voltage supplied by 930 is removed from the stack. An optional second pump 920 may be turned on to withdraw water from the collection container 926 (or optionally, from a separate water source) and direct it through the exit port 904 of the electrode stack. Water entering the exit port 904 then purges accumulated salt from the electrode stack 940 out through the inlet port 902. An actuator valve 934 (e.g., solenoid valve) may be present and configured to direct salt exiting the inlet port 902 during the salt purge cycle into an ejected waste container 924, which may then be sampled through port 936.

A particulate purge cycle may be used to remove solid particulate accumulated at the inlet end of the electrode stack during purification. In one example of a particulate purge cycle, positive pressure at the inlet port 902 provided by pump 922 may be released (e.g by turning off the pump) and the voltage supplied by 930 removed from the stack. Actuator valve 916 may be closed and a pump (optionally, pump 920 used during the salt purge cycle) may be turned on to withdraw water from the collection container and direct it through an open actuator valve 918 and to a second inlet port 906 of the electrode assembly 900. Water entering the second inlet port 906 then purges accumulated particulate from the electrode assembly 900 (for example, particulate accumulated between an upstream current collector and the electrode stack) out through the original inlet port. The same optionally present solenoid valve 934 used during the salt purge cycle may be present and configured to direct particulate exiting the original inlet port during the particulate purge cycle into an ejected waste container 924.

In some embodiments of the current invention, purification cycles are between about 1 and about 100 minutes in duration, or between about 5 and about 60 minutes, or between about 5 and about 45 minutes, or between about 5 and about 30 minutes, or between about 5 and about 15 minutes, or between about 5 and about 10 minutes, or between about 15 and about 30 minutes, or between about 10 and about 20 minutes.

In some embodiments of the invention, the purification cycle is terminated when the water pressure at the inlet port increases to a predefined level. The purification cycle may terminate when the pressure at the inlet port reaches about 15 pounds per square inch, or about 20 pounds per square inch, or about 25 pounds per square inch, or about 30 pounds per square inch, or about 35 pounds per square inch, or about 40 pounds per square inch, or about 50 pounds per square inch.

In some embodiments of the invention, the purification cycle ends when the electrical resistance of water at the outlet port decreases to a predefined level. In some embodiments, the purification cycle ends when the electrical resistance decreases to below about 1 kohm, or about 2 kohm, or about 5 kohm, or about 10 kohm, or about 20 kohm, or about 50 kohm, or about 100 kohm, or about 200 kohm, or about 500 kohm, or about 1 Mohm, or about 2 Mohm, or about 5 Mohm, or about 10 Mohm, or about 15 Mohm, or about 20 Mohm, or about 50 Mohm.

In some embodiments of the invention, the purification cycle ends when the conductivity of water at the outlet port increases to a predefined level. In some embodiments, the purification cycle ends when the electrical conductivity increases to above about 850 uS, or about 875 uS, or about 900 uS, or about 925 uS, or about 950 uS, or about 975 uS, or about 1000 uS.

In some embodiments of the present invention, the salt purge cycle and the particulate purge cycle are independently between about 5 and about 120 seconds in duration, or about 5 and about 60 seconds, or about 5 and about 30 seconds, or about 5 and about 15 seconds.

In some embodiments of the present invention, the salt purge cycle and particulate purge cycle occur simultaneously. In other embodiments, the salt purge and the particulate purge occur independently. In some of these embodiments, the particulate purge cycle occurs about once every 15 minutes, or about once every 30 minutes, or about once every 45 minutes, or about once every 60 minutes, or about once every 90 minutes, or about once every 120 minutes.

In some embodiments of the invention, the salt purge cycle and/or the particulate purge cycle are conducted using a gas. In some embodiments, the salt purge cycle and the particulate purge cycle are conducted using purified water. In other embodiments, the salt purge cycle and the particulate purge cycle are conducted using impure water. In yet other embodiments, one of the salt purge cycle and the particulate purge cycle is conducted using pure water and the other of the salt purge cycle and the particulate purge cycle are conducted using impure water. In some embodiments, the solvent used for the salt purge cycle and the particulate purge cycle is the same. In other embodiments, the solvent used for the salt purge cycle and the particulate purge cycle is different. In some embodiments, one or both of the salt purge cycle and the particulate purge cycle is conducted using an inorganic solvent. In some embodiments, one or both of the salt purge cycle and the particulate purge cycle is conducted using a solution comprising an inorganic solvent. In some embodiments, one or both of the salt purge cycle and the particulate purge cycle is conducted using an organic solvent. In some embodiments, one or both of the salt purge cycle and the particulate purge cycle is conducted using solution comprising an organic solvent. In some of these embodiments the inorganic solvent is hydrophilic. In other of these embodiments, the organic solvent is hydrophobic. In some embodiments of the invention, the solvent used in one or both of the salt purge cycle and the particulate purge cycle is intermittently changed to a different solvent.

In some embodiments of the current invention, the applied voltage is removed during the salt purge and/or particulate purge cycles. In other embodiments, the voltage across the electrode stack is shorted prior to a salt purge and/or particulate purge cycle to prevent residual voltage during the salt purge and/or particulate purge cycles. In some embodiments, the applied voltage is reversed during the salt purge and/or particulate purge cycles.

In some embodiments, the release of the pressure generated during the purification cycle may be used to expel concentrated salt within the system. In cases where salt is not adequately flushed from the electrode stacks, the stack may be shorted to eliminate any residual voltage across followed by a purge cycle using air to remove remaining salt. To prevent potential undesired shorting (and resulting chlorine gas generation) from compression forcing electrodes together during the purification cycle, a thicker and finer plastic mesh may be used to separate electrodes in the assembly stack. Additionally, sealing of the stack may be improved by first sealing the components individually and then together as an assembled unit.

Preventing air from being present in the system while the voltage is applied may prevent areas of high current density. In one embodiment, high current density is avoided by applying the voltage after water has started exiting the outlet port. In some embodiments, high current density is avoided by using a liquid rather than a gas during the salt purge cycle. Reducing the amount of air within the system may also shorten the purge cycle duration and reduce mixing of wastewater with purified water.

In some embodiments, during the particulate purge cycle, an actuator valve (e.g., solenoid valve) located near the exit port (such as 916 in FIG. 9) is closed while an actuator valve located near the second inlet port (such as 918 in FIG. 9) is open permitting flow through the second inlet port (906) and out through the inlet port (902). In some embodiments, during the salt purge cycle, an actuator valve located near the second inlet port is closed while an actuator valve located near the exit port is open, permitting flow through the exit port (904) and out through the inlet port (902). In some embodiments, during a combined salt and particulate purge, both an actuator valve located near the second inlet port (918) and an actuator valve located near the exit port (916) are open, permitting flow through second inlet port (906) and the exit port (904) out through the inlet port (902).

In some embodiments of the present invention, a single pump is used for the purification cycle and for both the salt purge cycle and the particulate purge cycle. In some of these embodiments, the single pump is used to pump liquid from an inlet to an outlet during the purification cycle and in a reverse direction for the salt purge cycle and the particulate purge cycle. In other embodiments, a single pump is used for the purification cycle and either the salt purge cycle or the particulate purge cycle and a second pump is used for the other of the salt purge cycle or the particulate purge cycle.

The apparatus may contain one or more sampling ports (e.g., connected to line 942 in FIG. 9) to collect water for analysis test (such as conductivity, ion concentration, etc.)), one or more valves (e.g. needle valve 928 in FIG. 9) may be connected to one or more bypass lines (such as 944 in FIG. 9) to control operating pressure. In some embodiments, one or more flowmeters, and/or one or more pressure gauges (e.g., 914 in FIG. 9) are included with the apparatus.

In some embodiments, the apparatus is controlled by an electronic control unit to modulate the duration and frequency of the purification and purge cycles. An electronic control unit may contain a 24 volt DC power supply to operate one or more pumps, and/or an on/off repeat cycle timer. A 4-channel relay may be used to open and close the electrical circuits to one or more pumps, valves, and/or one or more electrode stacks.

In some embodiments, the voltage supplied to different electrodes within an electrode stack may have a different value. For example, the voltage at one electrode set (such as an electrode pair) may be 2.4V, while the voltage at another electrode set (such as another electrode pair) within the same electrode stack may be 4.8V. In some embodiments the voltage supplied to the electrodes increases as the purification cycle progresses. In some embodiments, the voltage supplied to the electrodes increases as the electrical conductivity of water at the leaving the exit port increases. In some embodiments, the voltage supplied to the electrodes increases as the resistance of water leaving the exit port decreases. In some embodiments, the number of cathode electrodes is equal to the number of anode electrodes (e.g., four cathode electrodes and four anode electrodes). In other embodiments, the number of cathode electrodes is greater than the number of anode electrodes. In other embodiments, the number of anode electrodes is greater than the number of cathode electrodes.

Electrodes

The electrodes, which provide particle filtration, ionic species concentration and removal, and organic material and bacteria removal, may be carbon-based porous structures. In accordance with the embodiments shown in various drawings, the electrodes may be porous planar structures, i.e., plates, and the separator element is, for example, a perforated plate. However, any other configurations of electrodes and separator elements which provide the desired relationship between the electrodes and the separator element, such as tubular or rolled structures, may also be employed, and it is to be understood that such configurations are also considered to be within the scope of the invention claimed herein.

In some embodiments of the current invention, there are three basic components for an electrode: porosity, electrical conductivity, and mechanical strength. Accordingly, the electrodes may be carbon-based porous structures (optionally graphite) for conductivity, and may optionally comprise at least one oxide (e.g. metal oxide) for increasing water adsorption by the electrode, and a polymer (e.g., an ion-exchange, cross-linked, polarizable polymer) for binding the components of the electrode together and for providing mechanical strength to the electrode. The ion-exchange polymer component may also provide ion exchangeable groups on the surface of the electrode for binding ionic components of the water stream. In accordance with one embodiment of this invention, one, two, or more elements from Group-14 may be added (e.g. carbon black, to enhance the electrical conductivity of the electrode). In some of these embodiments, the added element may be in the weight percentage of about 5 to about 30 percent, about 5 to about 20 percent, or about 5 to about 10 percent. In some embodiments, the electrode may comprise carbon fibers, which may increase the mechanical strength of the electrode and/or silica, which may increase powder mixing uniformity and electrode wettability. In embodiments in which carbon fibers are added, this component is typically included at a weight percentage of about 5 to about 30 percent. In embodiments in which silica is added, this component is typically included at a weight percentage of less than about 5 percent. In some embodiments, other metals or semi-metals, such as silver or gold, may be added to the electrode that increase the conductivity and/or aid in inactivating microbes.

In some embodiments, electrodes of the invention comprise exfoliated graphite. Exfoliated graphite is the product of very rapid heating (or flash heating) of graphite intercalation compounds, such as graphite hydrogen sulfate, of relatively large particle diameter (flakes). Vaporization of intercalated substances force the graphite layers apart resulting in an accordion-like shape with an apparent volume typically hundreds of times that of the original graphite flakes. In accordance with one embodiment of this invention, a porous electrode as described herein comprises exfoliated graphite in the form of particles less than about 50 μm in size. In some embodiments, the exfoliated graphite may have a surface area of about 500 m²/g to about 800 m²/g. In some embodiments, the exfoliated graphite may have a surface area of about 700 m²/g.

In some embodiments of the present invention, the average pore size within the electrode is less than 1 μm, or less than 0.75 μm, or less than 0.6 μm, or less than 0.5 μm, or greater than 0.05 μm, or greater than 0.1 μm, or greater than 0.15 μm, or greater than 0.2 μm or greater than 0.25 μm.

In some embodiments of the present invention, the average pore area within the electrode is greater than 10 m²/g, or greater than 12 m²/g, or greater than 14 m²/g, or less than 30 m²/g, or less than 28 m²/g, or less than 25 m²/g.

In one embodiment, exfoliation of graphite is effected using graphite power (e.g., Superior Graphite Corporation, Chicago) mixed with an HNO₃/H₂SO₄ solution (e.g., 1:9 HNO₃:H₂SO₄ v/v). For example, 80 g of graphite power may be mixed with an HNO₃/H₂SO₄ solution, and then heated in a 900 to 1000° C. furnace for 3 minutes.

Electrically conductive adsorbent particles may have reactive groups at the particle surface that react with e.g., one or more cross-linking agents, to bind these adsorbent particles into the electrode structure. For example, carbon-based material (e.g., exfoliated graphite) may have C═O and C—OH groups on its surface. The C═O and C—OH groups are available for cross-linking with a polymer binder, which may increase the electrode's mechanical strength and reduce carbon erosion in water. The cross-links also trap fine carbon black particles in electrodes that contain carbon black, which reduces carbon black erosion.

In some embodiments of the present invention, the electrodes comprise at least one resin which may also be used to bind the components of the electrodes into a cohesive structure. In some embodiments, the resin has an ion-exchange component, which provides ion-exchange sites on the electrode. In accordance with one embodiment of this invention, the ion-exchange component is a cross-linked, polarizable polymer. Cross-linking of the polarizable polymer is may avoid dissolution of the polymer in the water stream being purified. Suitable polymers for use in the electrodes described herein may include cross-linkable polymers and may include ion exchange sites, e.g. polymers comprising —NH₂, —OH, —C═O, and/or —COOH groups. In some embodiments, the resin is a cation exchange resin. In some embodiments, the resin is an anion exchange resin. In some embodiments, the resin is a mixture of a separate cation exchange resin and a separate anion exchange resin. In some embodiments, the resin contains both cation exchange resin and anion exchange resin. Suitable ion-exchange, polarizable polymers include, but are not limited to, polyurethane, polyacrylic acid, sulfonated polystyrene, poly(vinyl alcohol) (PVA), poly(ethylene vinyl alcohol) (PEVA), cross-linked phenolic resin, polyethylene imine (PEI), and combinations thereof. Suitable agents for cross-linking of the polarizable polymers include glyoxal, ketones, such as acetone, aldehydes, such as formaldehyde and glutaraldehyde, methylene amine, amines, imines, amides, and combinations thereof. In some embodiments, the resin(s) have an average molecular weight of about 15,000 to about 50,000. In some embodiments, the resin(s) have an average molecular weight of about 30,000.

In some embodiments of the present invention, the electrodes have a thin polymeric membrane or layer. In some embodiments, the thin membrane is cellulose acetate coated onto one or more electrodes. In some embodiments, the thin membrane or layer is PEVA, PEI, or polyamide. Thin membranes, such as cellulose acetate, may aid in salt adsorption. In some embodiments, the thin membrane or layer is cellulose acetate membrane over a PEVA, PEI, or polyamide membrane. In some embodiments, the thin membrane or layer is between about 25 Å to about 175 Å in thickness, or about 50 Å to about 150 Å in thickness, or about 75 Å to about 125 Å in thickness, or about 100 Å in thickness. In some embodiments, a water purification system comprises different electrodes with different membranes or layers. For example, a water purification system may comprise one electrode containing a PEVA membrane and an adjacent electrode containing a cellulose acetate membrane on top of a PEVA membrane. In one embodiment, a water purification system contains one electrode located near the water inlet port containing a PEVA membrane, one adjacent electrode downstream of the first electrode containing a cellulose acetate membrane and optionally a PEVA layer between the cellulose acetate membrane and electrode layer, and two electrodes further downstream containing PEVA membranes.

The electrodes of this invention may have hydrophilic properties and, as previously indicated, may optionally have at least one oxide in the electrode for the purpose of increasing water adsorption. The oxide(s) may contribute to hydrophilicity of the electrode. Any oxide that is stable in water may be utilized. In some embodiments the oxide comprises a semimetal (e.g., silica). In some embodiments, the oxide is a metal oxide. In some embodiments, the oxides range in size from about 0.05 μm to about 0.5 μm. Examples of suitable metal oxides include TiO₂, Al₂O₃, and mixtures thereof.

It will be appreciated that, depending upon the composition of the water stream being treated, impurities such as oily tars and high organic species may collect on the electrode. Such impurities may be removed by periodic back-flushing or purging of the electrode, as described within. To enhance this process, in addition to hydrophilicity, the electrodes of this invention may also possess hydrophobic properties. Ions are surrounded by water in aqueous medium. Hydrophobic materials help to expel water, thus expelling ionic impurities. The balance between hydrophilicity and hydrophobicity of the electrode may be controlled, in accordance with one embodiment of this invention, by the appropriate selection of polarizable polymer and cross-linking agent. For example, poly(vinyl alcohol) (PVA) has fewer —CH₂— groups than poly(ethylene vinyl alcohol) (PEVA). In PEVA, the ethylene group provides hydrophobicity. Certain cross-linking agents, such as formaldehyde, have fewer carbon atoms than glutaraldehyde and glyoxal. Generally, as the number of carbon atoms/—CH₂— groups increases, hydrophobicity increases and hydrophilicity decreases. It has been found that polymers with one (1) to five (5) —CH₂— groups per e.g., hydroxyl group or other hydrophilic group present in the polymer prior to cross-linking may provide a desirable balance between hydrophilicity and hydrophobicity of the electrode. In some embodiments, the electrode contains a hydrophobic content of about 20% to about 50%. In some embodiments, the hydrophilicity is greater than about 60% and the hydrophobicity is less than about 40%. In accordance with one preferred embodiment of this invention, the electrode is provided with a hydrophobicity of up to about 50%. In some embodiments, electrodes comprise at least one hydrophobic group, for example, at least one C—C group, CH—CH group, or CH₂—CH₂ group in the polymer.

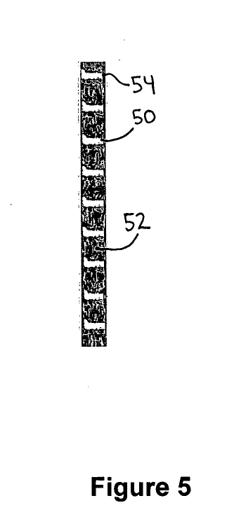

FIG. 5 depicts some embodiments wherein porous electrodes as described herein (such as 52) comprise microchannels 50. In some embodiments, the microchannels have an average diameter that is greater than average diameter of pores in the electrode. In some embodiments, the microchannels have an average diameter that is greater than average diameter of pores in the electrode, but less than the average diameter of particulates carried by the waste or water to be purified. A microchannel may be covered with a water permeable polymeric membrane 54 at each end opening to the surface of the electrode and/or in the interior of the microchannel. In some embodiments, microchannel coverings may be limited to the area at each end opening to the surface of the electrode and formed during fabrication. In some embodiments, microchannels may be covered by a separate thin membrane or layer applied following formation of the microchannels. Microchannels may increase water permeability and surface area of the electrode available for ion adsorption by providing better access to additional pores, ion exchange sites, and adsorbents, while the membrane may prevent particulates from passing into or through the microchannels. In some embodiments, the microchannels have a larger diameter than the electrode pores. It may be desirable to provide microchannels having a diameter sufficiently large to allow increased water permeability without decreasing ion adsorption. In some embodiments, microchannels have diameters from about 0.1 mm to about 1 mm. In some embodiments, microchannels have diameters from about 0.5 mm to about 1 mm. In some embodiment, microchannels are spaced about 2 to about 10 mm apart. In one embodiment, microchannels are spaced about 5 mm apart. In some embodiments, the microchannels comprise diameters of about 0.3 to about 0.2 cm with a distance of about 0.5 cm between microchannels In some embodiments, the thin membrane is between about 10 Å to about 200 Å in thickness, or about 20 Å to about 150 Å in thickness, or about 50 Å to about 125 Å in thickness, or about 100 Å in thickness.

In some embodiments, the electrodes may be separator plates described in U.S. Pat. No. 5,942,347, the content of which is herein incorporated by reference for all purposes in its entirety.

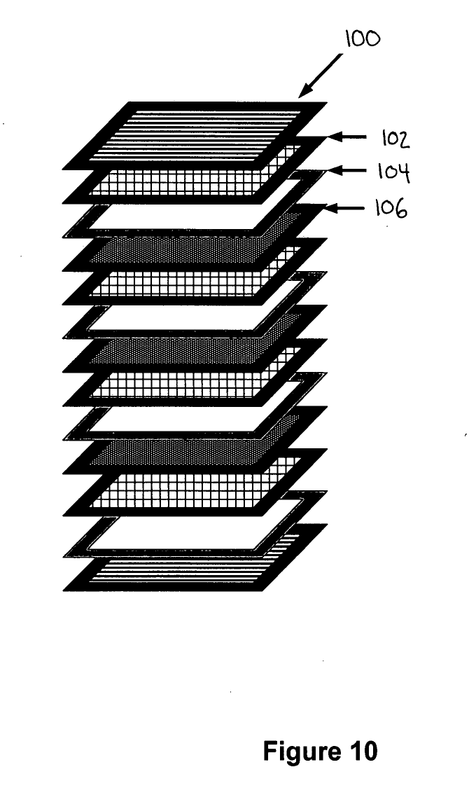

In some embodiments, the electrodes as described herein comprise a seal applied to the electrode edges (e.g., water-based acrylic rubber (and other liquid-based polyurethanes), polycarbonate, or silicone). Seals may prevent leaking from the sides of the electrode assembly and/or prevent edge degradation, breaking, and water bypassing while the water purification system is under pressure, as well as providing added stiffness when the electrodes are stacked. The seals may also help distribute pressure during operation to the edges of the electrodes rather than the active area of the electrodes. Applying the seals may be accomplished by dip-coating the electrode edges. In some embodiments, portions of the electrodes may be coated with one or more non-conducting materials (e.g., polytetrafluoroethylene) to provide electrical insulation. In some embodiments, the sealant applied to the edges of the electrode may be sufficiently thick to avoid electrical shorting across electrodes in an electrode stack. FIG. 10 shows one embodiment, wherein the electrodes 106 comprise one or more adjacent gaskets 104 (e.g., one or more silicone foam gaskets) to aid in sealing unevenness of the electrode surface and/or adjacent layer of an electrode stack (e.g., a fluid-permeable separator, such as a mesh). In some embodiments, the gasket may be sufficiently thick to avoid electrical shorting across electrodes in an electrode stack. In some embodiments of the current invention, the plates and/or layers of the electrodes stack are sufficiently supported at the center of the electrode stack (e.g., by having adjacent layers in contact with one another) to prevent excessive forces from damaging the water purification system during operation.

Electrode Fabrication

In general, the electrodes of this invention may be produced by mixing an oxide (e.g., metal oxide) and carbon or exfoliated graphite powders with a polymer resin (polymer solution containing cross-linking agent) and a bubbler, such as ammonium bicarbonate or sodium bicarbonate, and molding (e.g., casting) the mixture at atmospheric pressure and room temperature or an elevated temperature. The amount of ammonium bicarbonate or other bubbler employed depends on the desired porosity of the water permeable electrode. Typically, the electrode contains about 40% to about 80% porosity, depending on the desired balance of conductivity and mechanical strength. It has been found that a mixture comprising about 50-60 wt % graphite powders, about 5-20 wt % carbon black, about 7 wt % polymer resin and up to about 10 wt % ammonium bicarbonate molded at room temperature or an elevated temperature, for example, 200° C., produces a suitable electrode. The polymer may be cross-linked after evaporation of solvent.

In one embodiment, an electrode produced as described herein is treated in a hot water bath at about 50 to about 90° C. to remove solvent residue and cross-linked catalyst.

In some embodiments, microchannels are introduced into an electrode of the invention during fabrication. In one embodiment, a casted electrode sheet comprising exfoliated graphite, metal oxide, polymeric binder (e.g., PEVA, PVA, or PEI), and/or other materials such as carbon black, silica, and/or carbon fibers, is allowed to dry at room temperature. Before the sheet is completely dry, small holes to create microchannels are introduced through the entire thickness of the sheet, for example, with pins or laser drills. Liquid polymer (e.g., PEVA) covers the ends of the pinholes at the front and back surfaces of the electrode sheet, and then dries, forming a thin water permeable membrane covering the ends of each microchannel.

Current Collector

The water purification system as described herein may comprise a current collector embedded within or contacting the edges of an electrode. The current collector is designed to evenly distribute liquid to the surface of an adjacent electrode for constant pressure at the electrode interface resulting in improved filtration. In some embodiments, the current collector is separated from an electrode by one or more layers (e.g., a fluid permeable separator, a silicone foam gasket, or both). As shown in FIG. 10, a current collector 100 may be located at one end of an electrode stack such that liquid is directed through the current collector prior to distribution to one or more electrodes of the electrode stack.

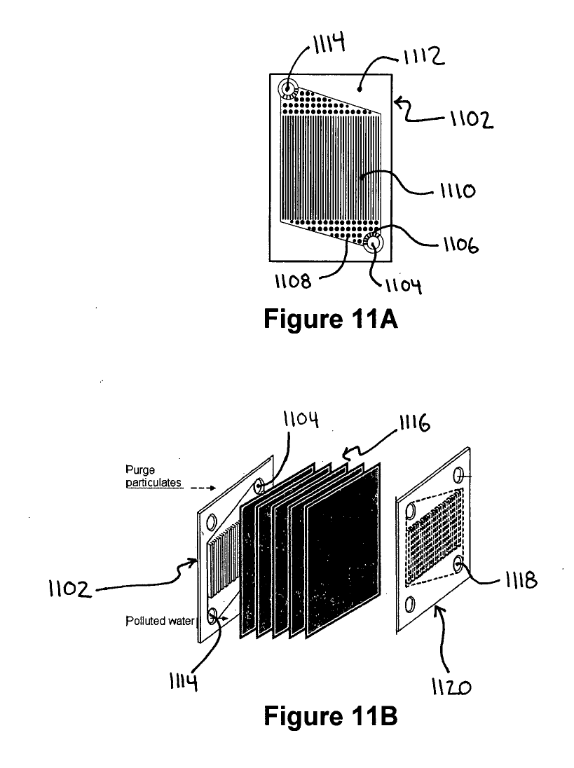

FIG. 11A shows a front view of a current collector in one embodiment of the current invention. A flat surface 1112 may allow proper sealing with an adjacent electrode and a cavity within the surface. One port 1114 may be used as an inlet wherein liquid may be directed into the cavity of the current collector and evenly delivered to the electrode surface. Fingers 1106 near port 1114 may allow even distribution of water entering the current collector and may also support the area surrounding the port during high pressure operations. Adjacent to port 1104 and 1114 may be dimples 1108 to thoroughly disrupt current flow and aid in preventing areas of high pressure on adjacent plates. Parallel veins 1110 may also aid in distributing incoming water evenly across the entire cavity. An additional port 1104 may be used for purging particulates accumulated on the electrode surface. The current collector may comprise a metal gauze or sheet, such as, for example, stainless steel, nickel, or titanium. In some embodiments, the current collector may be constructed of graphite to prevent corrosion. FIG. 11B shows one embodiment of the present invention, wherein an upstream current collector 1102 of FIG. 11A is located on one end of an electrode stack and a downstream current collector 1120 is located on the opposite end of the electrode stack. The down stream current collector 1120 is shown with an optionally present exit port 1118. In some embodiments, the current collector contains multiple inlet and/or outlet ports (such as the additional exit port shown in FIG. 11B diagonal to 1118).

Fluid Permeable Separator

The water purification system as described herein may contain an electrically nonconductive, fluid permeable separator situated between the porous anode and cathode electrodes. The separator may help maintain flow uniformity (allowing liquid to redistribute between filters and equalize pressure) and prevent electrical short-circuiting during operation of the device. The fluid permeable separator may provide structural support to the electrode stack. In one embodiment, the fluid permeable separator element is a non-electron conductive material, such as commercially available perforated plastic sheet, for example perforated polyethylene, polypropylene, plastic mesh, glass fiber paper, other non-electron conductive fiber paper, woven cloth, water permeable anion conductive membrane, or water permeable cation conductive membrane, such as polyamide, polyvinyl alcohol, or polyethylene imine, having an open area of about 40% to about 80%, about 50% to about 70%, or about 60%, enabling flow through of the water stream to be purified. In some embodiments (as shown in FIG. 10), the fluid permeable separator 102 may be oriented directly adjacent to an electrode 106, a current collector 100, and/or a gasket 104 (e.g., silicone foam gasket). Gaskets (e.g., silicone foam gaskets) may also aid in preventing electrostatic buildup during filtration operation.

Housing

The water purification system described herein may contain a housing having an inlet port through which water to be purified is introduced into the water purification system, and an outlet port through which purified water exits the system.

The housing may be composed of an electrically non-conductive material such as plexiglass, polycarbonate, or polyurethane, which are injection moldable. In some embodiments, the housing is a conductive material that is coated with a non-conductive material. The housing may contain an inlet port for introducing the water stream to be purified into the system for processing and a purified water outlet port through which purified water may be removed. In some embodiments, the housing also contains an exhaust waste outlet opening through which particulates separated out of the water stream may be removed. In some embodiments, the inlet opening and the optional exhaust waste outlet are located upstream from the first porous electrode through which the water stream flows, and the purified water outlet opening is located downstream from the last electrode through which the water stream flows. In some embodiments, the inlet opening is located near the bottom of the housing to facilitate removal of particulate and other solid matter in the water stream too large to traverse the pores of the electrodes through an exhaust outlet at the bottom of the housing. In some embodiments, the purified water outlet is located at the top of the housing downstream from the last electrode through which the water stream flows. In some embodiments, the housing also contains a second inlet port located upstream from the first electrode to introduce a water stream used during a particulate purging process (see 808 in FIG. 8).

In some embodiments the housing is comprised of endplates (e.g. plastic endplates) separated by an electrode stack, (see 810 and 812 in FIG. 8). The housing may contain spacers (816 in FIG. 8) between the endplates to prevent leakage through the edges of the electrode stack during standard operation. In some embodiments, the housing comprises a means of compressing the electrode stack (e.g., tie rods 814 as depicted in FIG. 8).

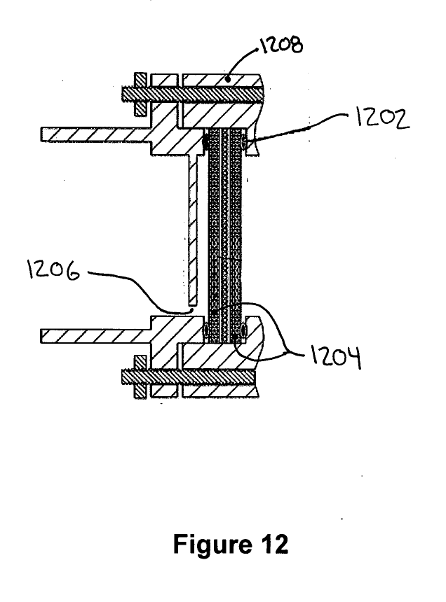

FIG. 12 shows another variation of the invention wherein the electrodes 1204 may be held in place in the housing 1208 with gaskets 1202 and may be sealed at their top and bottom edges with polyurethane or another insulator.

In some embodiments of the current invention, some or all material of the water purification system in contact with waste or water is non-metallic to reduce or eliminate corrosion.

The following examples are intended to illustrate but not limit the invention.

### EXAMPLE 1

### Production of Exfoliated Graphite

Exfoliated graphite was produced by mixing concentrated sulfuric acid and graphite powders. The mixture was heated in an oven at 600° to 1000° C. The resulting expanded graphite includes C═O and C—OH bonds on the graphite particles, which crosslink with poly(ethylene vinyl alcohol) and glutaraldehyde. The resulting graphite powders are stable in the porous plate and can not wash out during the wastewater treatment process.

### EXAMPLE 2

### Production of Porous Graphite Electrode

9 grams of exfoliated graphite powders were mixed with 10 grams of water and 10 grams of 10 wt % polyvinyl alcohol), forming a first mixture. 10 grams of water were mixed with 2 grams of 50 wt % glutaraldehyde in water and 0.5 ml HCl (35 wt %), forming a second mixture. The two mixtures were mixed together thoroughly and the resulting mixture was cast to produce a 1/16″ thick sheet which was then heat treated at 100° C. Water boiling from the plate generated bubbles, making the plate porous. Because glutaraldehyde binds with poly(vinyl alcohol) in an irreversible fashion, the resulting cross-linked polymer was entirely insoluble, even in hot water. In some experiments, PEVA was used as a binder to increase the electrode strength. The solvent for PEVA was 1:1 volume ratio of 1-propanol and water.

Table 1 shows a comparison of surface resistance between the electrode produced in accordance with this example and other electrode materials.

TABLE 1
Surface Resistance Comparison

| Material | Surface Resistance (Ω) |
|---|---|
| Gold-plated copper | 0.098 |
| Dense Composite Graphite | 0.120 |
| Porous Graphite Sheet | 95 |

### EXAMPLE 3

### Variation of Electrode Porosity by using Different Bubble Agents

Two graphite-based porous electrodes were produced using different bubble agents. 8 grams of exfoliated graphite powder and 1 gram of bubble agent (ammonium bicarbonate or sodium bicarbonate) were mixed with 10 grams of water and 10 grams of 10 wt % polyvinyl alcohol, forming a first mixture. 10 grams of water were mixed with 2 grams of 50 wt % glutaraldehyde and 1.5 ml HCl (35 wt %), forming a second mixture. The two mixtures were mixed thoroughly and the resulting mixture was cast to produce a 1/16 in thick sheet. The sheet was cured at room temperature. Since glutaraldehyde binds with polyvinyl alcohol in an irreversible fashion, the resulting cross-linked polymer was insoluble, even in hot water.

Electrodes produced with or without bubble agent were produced as described in Example 2 and tested in a system without applied water pressure. An electrode produced with no bubble agent had low water permeability (<1 ml/min), and the electrode produced with bubble agent exhibited great improvement in permeability (>20 ml/min). However, the tensile strength of electrodes produced with bubble agents was reduced approximately 20%.

### EXAMPLE 4

### Optimization of Porous Graphite-Based Electrode Composition

Fourteen porous graphite-based electrodes with different compositions were produced as described in Example 2 using a matrix optimization method. The compositions of these electrodes are shown in Table 2.

TABLE 2
Electrode Compositions

| | | | | | | | | 1:1 DI | 50% | |
|---|---|---|---|---|---|---|---|---|---|---|
| | | Carbon | Carbon | | | | PEVA/ | Water/ | glutar- | |
| | Exfoliated | Black | Fiber | | | | PEI | 1- | aldehyde | 35% |
| | Graphite | XC-72R | Panex | Silica | PEI | PEVA | Solution | propanol | in Water | HCl |
| Trial | (g) | (g) | 30 (g) | (g) | (%) | (%) | (g) | (ml) | (ml) | (ml) |
| 1 | 10 | 2 | 6 | | 0 | 10 | 15 | 20 | 5 | 0.75 |
| 2 | 14 | 3 | 1 | | 0 | 5 | 40 | | 5 | 0.75 |
| 3 | 13 | 5 | 0 | | 0 | 5 | 30 | 30 | 5 | 0.75 |
| 4 | 13 | 3 | 0 | | 0 | 5 | 40 | 20 | 5 | 0.75 |
| 5 | 20 | 4 | 12 | | 0 | 10 | 24 | 60 | 6 | 1 |
| 6 | 10 | 2 | 6 | | 0 | 10 | 10 | 30 | 3 | 0.5 |
| 7 | 20 | 4 | 12 | | 0 | 10 | 24 | 60 | 6 | 1 |
| 8 | 13 | 3 | | | 0 | 10 | 20 | 45 | 5 | 1 |
| 9 | 14 | 4 | | | 0 | 10 | 20 | 15 | 5 | 0.75 |
| 10 | 10 | 2 | 6 | | 0 | 10 | 20 | 15 | 5 | 0.75 |
| 11 | 14 | 3 | 9 | 1 | 0 | 10 | 30 | 23 | 7 | 1.25 |
| 12 | 14 | 3 | 9 | 1 | 0 | 10 | 30 | 23 | 7 | 1.25 |
| 13 | 24 | 4 | 8 | | 0 | 10 | 30 | 60 | 7 | 1.25 |
| 14 | 24 | 4 | 8 | 0 | 5 | 9.5 | 30 | 60 | 7 | 1.25 |

We tested the electrodes for their ability to remove salt from salt water in a gravity-drived device. 25 to 30% of the salt was removed after filtration. Results with selected electrodes are shown in Table 3.

TABLE 3
Salt Removal with Selected Electrode Compositions

| | | | | | | Salt |
|---|---|---|---|---|---|---|
| | | Current | | Solution | Outlet | Re- |
| | Voltage | Density | NaCl | Conductivity | Conductivity | duction |
| Trial | (V) | (mA/cm²) | (%) | (μS) | (μS) | (%) |
| 1 | 1.3 | 0.17 | 0.01 | 229 | 197 | 14 |
| 2 | 1.3 | 0.17 | 0.01 | 219 | 201 | 8.2 |
| 3 | 1.3 | 0.69 | 0.01 | 225 | 151 | 32.9 |
| 9 | 1.3 | 0.17 | 0.01 | 206 | 186 | 9.7 |

### EXAMPLE 5

### Variation of Electrode Porosity using Different Binder Concentrations

The porosity of electrodes was analyzed as a function of PEVA binder concentration. Binder concentrations of 5%, 7.5%, and 10% were used in preparation of the electrodes. The electrodes contained 10% carbon black and 10% carbon fiber. The porosity was tested using the BET (Brunauer, Emmett, and Teller) method to determine electrode properties such as gas uptake, micropore volume (t-plot method), porosity, and pore size distribution via adsorption and desorption isotherms. The results are shown in Table 4. The porosity of the electrode decreased as the amount of binder increased.

TABLE 4
Porosity Analysis

| Composition | 5% Binder | 7.5% Binder | 10% Binder |
|---|---|---|---|
| Total Intrusion Volume (ml/g) | 1.8393 | 1.3900 | 1.0715 |
| Total Pore Area (m²/g) | 14.107 | 23.931 | 23.714 |
| Median Pore Diameter | 1.9805 | 0.6881 | 0.5488 |
| (Volume) (μm) | | | |
| Median Pore Diameter (area) | 0.1116 | 0.0669 | 0.0555 |
| (μm) | | | |
| Average Pore Diameter (4 V/A) | 0.5215 | 0.2323 | 0.1807 |
| (μm) | | | |
| Bulk Density at 25 psia (g/ml) | 0.5326 | 0.5368 | 0.6528 |
| Apparent (Skeletal) Density | 1.7390 | 1.7127 | 1.7468 |
| (g/ml) | | | |
| Porosity (%) | 76.1814 | 71.5888 | 65.1779 |
| Surface Resistance (Ω/cm) | 32 | 25 | 22 |

### EXAMPLE 6

### Filtration of Ferric Nitrate

We tested the ability of the filter electrodes to remove iron from a 1 M ferric nitrate solution. 50 mL of a 0.01 M ferric nitrate solution and 0.01 M lead nitrate solution were filtered through a gravity-driven device, using electrodes with a composition containing 7.5% PEVA, 62.5% exfoliated graphite, 10% carbon black, and 20% carbon fiber. The solution was visually bright yellow prior to filtration, and the filtered solution was light yellow in color, indicating that iron ions had been removed by filtration. 7.7 mg iron was filtered per gram of electrode and 15.4 mg lead was filtered per gram of electrode, as shown in Table 5.

TABLE 5
Filtration Study

| | Pre- | | Ion mg/g |
|---|---|---|---|
| | filtered | Filtered | electrode |
| Iron (mg/L) | 609 | 55 | 7.7 |
| Lead (mg/L) | 2250 | 110 | 15.4 |
| Nitrate (mg/L) | 4090 | 350 | 49 |
| NO₃ | | | |

### EXAMPLE 7

### Filtration Under Pressure

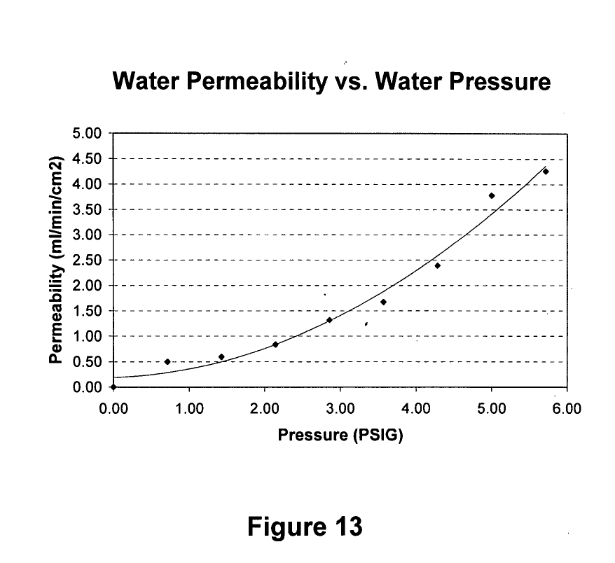

We also tested a three-stage pressure-driven device, depicted schematically in FIG. 6A, using electrodes with a composition containing 7.5% PEVA, 62.5% exfoliated graphite, 10% carbon black, and 20% carbon fiber. The device was operated under varying pressure conditions. The flow rate increased versus the flow rate under gravity alone. The flow rate increased as a function of pressure, as shown in Table 6 and FIG. 13.

TABLE 6
Water Flow Rates under Different Pressures

| | Pressure (inch water) | | | | | | | |
|---|---|---|---|---|---|---|---|---|
| | 20 | 40 | 60 | 80 | 100 | 120 | 140 | 160 |
| Flow rate | 0.50 | 0.62 | 0.83 | 1.31 | 1.70 | 2.47 | 3.80 | 4.25 |
| (ml/min/cm²) | | | | | | | | |

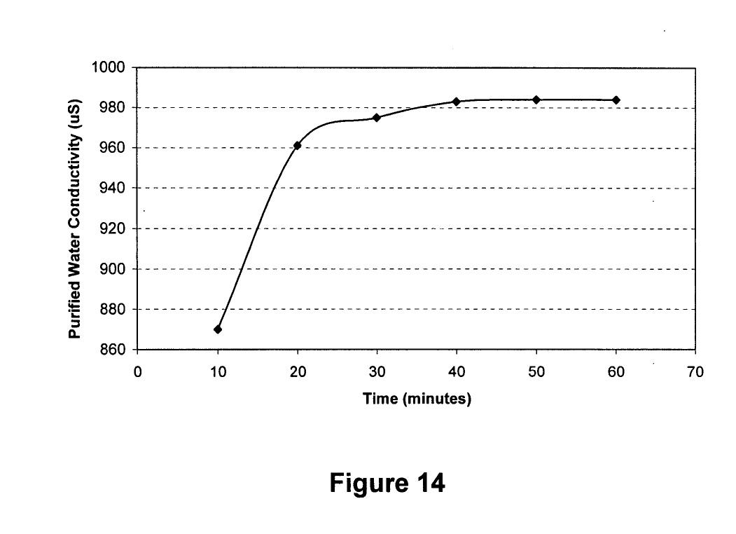

FIG. 14 shows effluent conductivity over time at a pressure of 20 inch H₂O. The electrode area was approximately 12 cm².

### EXAMPLE 8

### Porous Graphite-Based Electrodes with Microchannels

Microchannels were introduced into the porous graphite-based electrodes during fabrication, to increase water permeability and ion adsorption. Electrodes were prepared by mixing exfoliated graphite powder with carbon black, metal oxide, and optionally carbon fibers and/or silica. Then, one or more binders, such as PEVA, PVA, and/or PEI were added. The slurry was mixed well. A cross-linking agent was added to the slurry and mixed well. The slurry was cast to a thickness of 0.75 mm. The cast sheet was partially dried at room temperature about 5 to 30 minutes to retain 60 to 80% solvent in the electrode, then punched with pins about 0.3 mm in diameter and about 5 mm apart. The polymeric binder formed a thin, water permeable membrane at each end of a microchannel as it opened to the surface of the electrode (see FIG. 5). The microchannels increase water transport radiance in all directions, and increase the total surface area available for ion adsorption in the porous electrode. The microchannels form saturated zones for ionic adsorption, thus reducing “dead zones” that are difficult for water to enter.

### EXAMPLE 9

### Automated Continuous Water Treatment

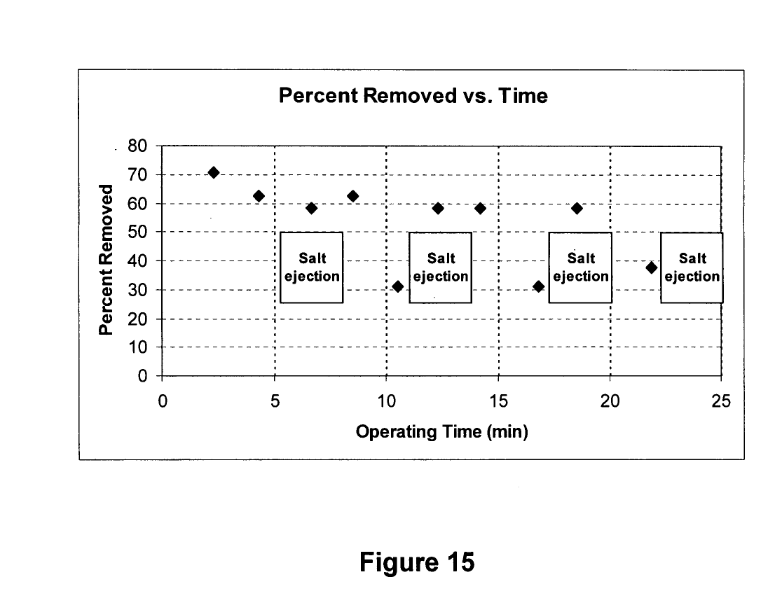

The assembly method described within was used to produce a sealed three electrode stack illustrated in FIG. 8. The stack was tested in the automated continuous test apparatus as shown in FIG. 9 with 1% NaCl in water (simulated wastewater) as the liquid to be purified. The conductivity of the product water was analyzed by collecting samples from the sample port. The results (FIG. 15) show an initial 60% reduction in salt content before backflushing (purging). Backflushing at 5 min intervals showed the system is stable and capable of removing predictable amounts of salt.

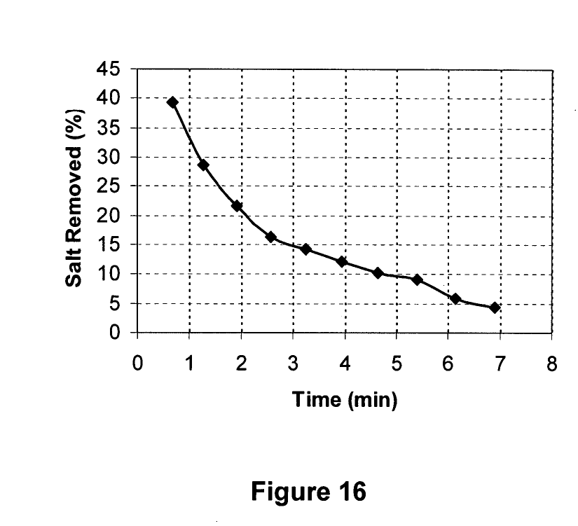

Another sealed three electrode stack described was tested in the automated continuous test apparatus with 3% NaCl in water (simulated seawater) as the liquid to be purified. The conductivity of the product water was analyzed by collecting samples from the sample port. The results (FIG. 16) show an initial 40% reduction in salt content prior to backflushing (purging).

All publications, patents, and patent applications cited herein are hereby incorporated by reference in their entireties for all purposes and to the same extent as if each individual publication, patent, or patent application were specifically and individually indicated to be so incorporated by reference.

Although the foregoing invention has been described in some detail by way of illustration and examples for purposes of clarity of understanding, it will be apparent to those skilled in the art that certain changes and modifications may be practiced without departing from the spirit and scope of the invention. Therefore, the description should not be construed as limiting the scope of the invention, which is delineated by the appended claims.

What is claimed is:

1. A water purification system comprising:
a porous anode electrode and a porous cathode electrode, each of said electrodes comprising graphite, and at least one cross-linked, polarizable polymer comprising ion-exchange groups; and
an electrically non-conductive, fluid permeable separator element disposed between said anode electrode and said cathode electrode.

2. A water purification system in accordance with claim 1, wherein said at least one polymer comprises a polymer selected from the group consisting of polyurethane, polyacrylic acid, sulfonated polystyrene, poly (vinyl alcohol), poly(ethylene vinyl alcohol), polyethylene imine, and combinations thereof.

3. A water purification system in accordance with claim 1, wherein said polymer is cross-linked with a cross-linking agent selected from the group consisting of glyoxal, formaldehyde, glutaraldehyde, methylene amine, and combinations thereof.

4. A water purification system in accordance with claim 1, wherein said graphite is exfoliated graphite.

5. A water purification system in accordance with claim 4, wherein said exfoliated graphite comprises exfoliated graphite particles having a particle size less than about 75 μm in diameter.

6. A water purification system in accordance with claim 1, wherein said anode and cathode electrodes and said separator element are disposed within an electrically nonconductive housing comprising an inlet opening and an outlet opening, wherein said water purification system is adapted such that a water stream to be purified flows from said inlet to said outlet through said anode electrode, said separator, and said cathode electrode.

7. A water purification system in accordance with claim 1, wherein said electrodes are substantially hydrophilic.

8. A water purification system in accordance with claim 7, wherein said electrodes comprise at least one hydrophobic group.

9. A water purification system in accordance with claim 1, wherein one of said electrodes comprises a current collector adjacent to a surface of one of said electrodes.

10. A water purification system in accordance with claim 1, wherein said electrically non-conductive, fluid permeable separator element is a perforated plastic sheet comprising an open area of at least about 40% to about 80%.

11. A water purification system in accordance with claim 1, wherein at least one of said electrodes comprises carbon black.

12. A water purification system in accordance with claim 1, wherein said electrodes comprise a porosity of at least about 50% to about 80% by volume of said electrodes.

13. A water purification system in accordance with claim 1, wherein said electrodes comprise microchannels.

14. A water purification system in accordance with claim 1, wherein one of said electrodes comprises a seal in contact with at least one surface of one of said electrodes.

15. A water purification system in accordance with claim 14, wherein said seal comprises acrylic rubber.

16. A water purification system in accordance with claim 1, further comprising a gasket element disposed between said anode electrode and said cathode electrode.

17. A water purification system in accordance with claim 16, wherein said gasket element comprises silicon foam.

18. An electrode for use in a water purification system, comprising graphite, and at least one cross-linked, polarizable polymer comprising ion-exchange groups, and comprising a porosity of at least about 50% by volume of said electrode.

19. An electrode in accordance with claim 18, wherein said polymer comprises a polymer selected from the group consisting of polyurethane, polyacrylic acid, sulfonated polystyrene, poly (vinyl alcohol), poly(ethylene vinyl alcohol), polyethylene imine and combinations thereof.

20. An electrode in accordance with claim 18, wherein said graphite is exfoliated graphite comprising exfoliated graphite particles having a particle size less than about 75 μm in diameter.

21. An electrode in accordance with claim 18, wherein said polymer is cross-linked with a cross-linking agent selected from the group consisting of glyoxal, formaldehyde, glutaraldehyde, methylene amine, and combinations thereof.

22. An electrode in accordance with claim 18, wherein said electrode is substantially hydrophilic.

23. An electrode in accordance with claim 22, wherein said electrode comprises at least one hydrophobic group.

24. An electrode in accordance with claim 18, further comprising carbon black dispersed substantially uniformly throughout said electrode.

25. An electrode in accordance with claim 18, wherein said electrodes comprise microchannels.

26. An electrode in accordance with claim 18, wherein said electrode comprises front and back surfaces, wherein said microchannels comprise openings at said front and back electrode surfaces, and wherein said electrode comprises a thin layer polymeric membrane covering the microchannel openings on the front and back surfaces of the electrode.

27. A method of removing impurities in water, comprising the steps of:
applying a voltage to the electrodes of the water purification system comprising:
an anode electrode and a cathode electrode, each of said electrodes comprising graphite, at least one metal oxide, and at least one cross-linked, polarizable polymer comprising ion-exchange groups; and an electrically non-conductive, fluid permeable separator element disposed between said anode electrode and said cathode electrode.
contacting said electrodes with water, whereby impurities in said water are removed by one of said electrodes; and
collecting said water from said electrodes.

28. A method of removing impurities in water, comprising the steps of:
providing a water purification system comprising: a housing, an anode electrode and a cathode electrode within said housing, a first water inlet port and a water outlet port on said housing;
introducing a first water stream in a forward direction into said first water inlet port;
applying a voltage to said anode electrode and said cathode electrode, whereby impurities in said first water stream are removed by one of said electrodes;
removing said voltage from said anode electrode and said cathode electrode;
collecting said first water stream from said water outlet port; and
introducing a second water stream in a reverse direction into said water purification system, whereby said impurities removed by one of said electrodes are removed from one of said electrodes.

29. A method in accordance with claim 28, further comprising the step of:
introducing a third water stream in a forward direction into a second water inlet port of said water purification system, whereby particulates accumulated on one of said electrodes are removed from one of said electrodes.
